(19) United States
(12) Patent Application Publication
(10) Pub. No.: US 2015/0347125 A1
(43) Pub. Date: Dec. 3, 2015

(54) HYBRID DIGITAL SCRUM BOARD

(71) Applicant: Wal-Mart Stores, Inc., Bentonville, AR (US)

(72) Inventors: Donald High, Noel, MO (US); Henry Sampara, Bentonville, AR (US)

(21) Appl. No.: 14/728,706

(22) Filed: Jun. 2, 2015

Related U.S. Application Data
(60) Provisional application No. 62/006,587, filed on Jun. 2, 2014.

(51) Int. Cl. G06F 9/44; G06F 3/0484; G06F 3/0482

(52) U.S. Cl. CPC G06F 8/70; G06F 3/0482; G06F 3/04842

(57) ABSTRACT

A computing device that generates a graphical user interface representing an electronic scrum board is provided. The electronic scrum board can be accessed locally and remotely by team members. Based on login credentials, the team member who is accessing the electronic scrum board can only view authorized sticky notes on the electronic scrum board. Movement of the sticky notes can also cause movement of a corresponding sticky note on another scrum board if the task is linked.

### RELATED APPLICATIONS

This application claims priority to U.S. Provisional Patent Application No. 62/006,587, filed Jun. 2, 2014, the contents of which are incorporated herein by reference in their entirety.

### FIELD OF THE INVENTION

The disclosure relates generally to interactive project management systems and more particularly to a hybrid digital scrum board for managing software development projects.

### BACKGROUND OF THE INVENTION

Businesses tend to have various ongoing projects with varying tasks and deadlines, and designated people assigned to such projects. For example, a deadline can be a Sprint, which typically has a 30-day timeframe. A project lead needs resources so that he can keep track of the status of the various tasks and deadlines. Tasks and deadlines are tracked via a conventional scrum board such as a corkboard, chalkboard, or whiteboard along with sticky notes in order to keep track of various projects. However, the conventional scrum board can be accidentally erased or the sticky notes may fall down and get lost. Additionally, conventional scrum boards do not allow for various versions to be saved for later use or for remote access, thereby limiting the usefulness of conventional scrum boards.

### SUMMARY OF THE INVENTION

Methods and systems are provided herein for a computing device that in some embodiments includes a processor that controls the computing device, a memory that stores software with instructions to configure a graphical user interface representing an electronic scrum board, a display that displays the graphical user interface representing the electronic scrum board, the electronic scrum board having a plurality of sections, each section including a plurality of interactive user interface elements (e.g., electronic sticky notes), an input device that receives an input from a user, and a communication interface that allows the computing device to communicate with a remote device via a wired or wireless connection, wherein based on a log in credential of the user, the user is only allowed to view and manipulate an authorized sticky note of the plurality of electronic sticky notes.

There has thus been outlined certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining various embodiments of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a computing device that includes software to implement the invention according to an embodiment of the invention.

FIG. 2 illustrates an exemplary scrum board according to an embodiment of the invention.

FIG. 3 illustrates exemplary sticky notes that can be used according to embodiments of the invention.

FIG. 4 illustrates various electronic devices that can access a network on which the computing device containing the electronic scrum board is connected to.

FIG. 5 illustrates a method of moving the sticky note 214 according to an embodiment of the invention.

### DETAILED DESCRIPTION

The invention will now be described with reference to the drawing figures, in which like reference numerals refer to like parts throughout. An embodiment in accordance with the present invention provides an electronic scrum board that can be saved and accessed remotely or in person. Typically a project meeting takes place at least once week or once a day. The project team members will meet in a room with a scrum board according to an embodiment of the invention, and discuss the status of each task on the scrum board. Team members who are not able to be in the room can access the scrum board remotely and participate in the meeting.

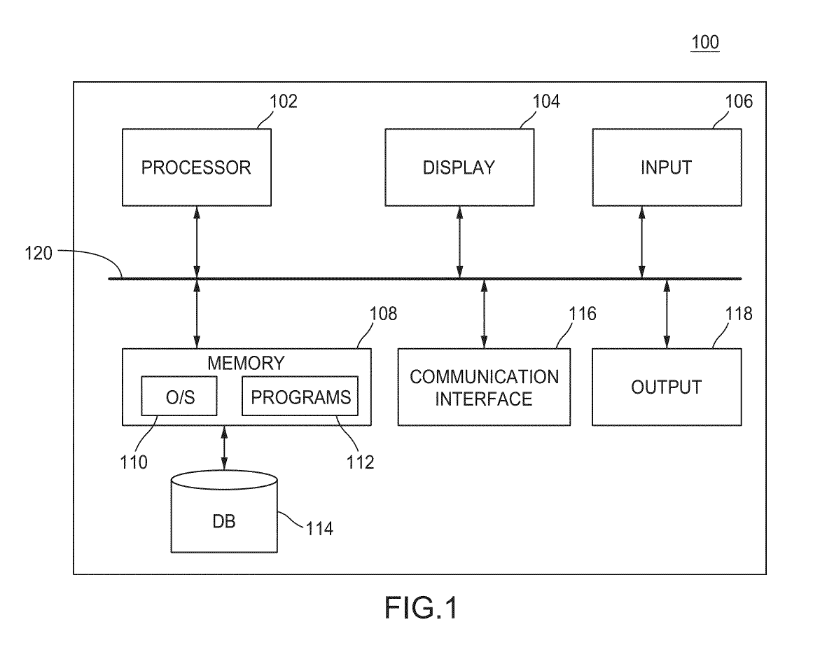

FIG. 1 illustrates a computing device 100 that includes software to implement the invention according to an embodiment of the invention. The computing device 100 can include a processor 102, a display 104, an input device 106, memory 108 that includes an operating system 110, programs 112, a database 114, a communication interface 116, an output device 118 and a network bus 120.

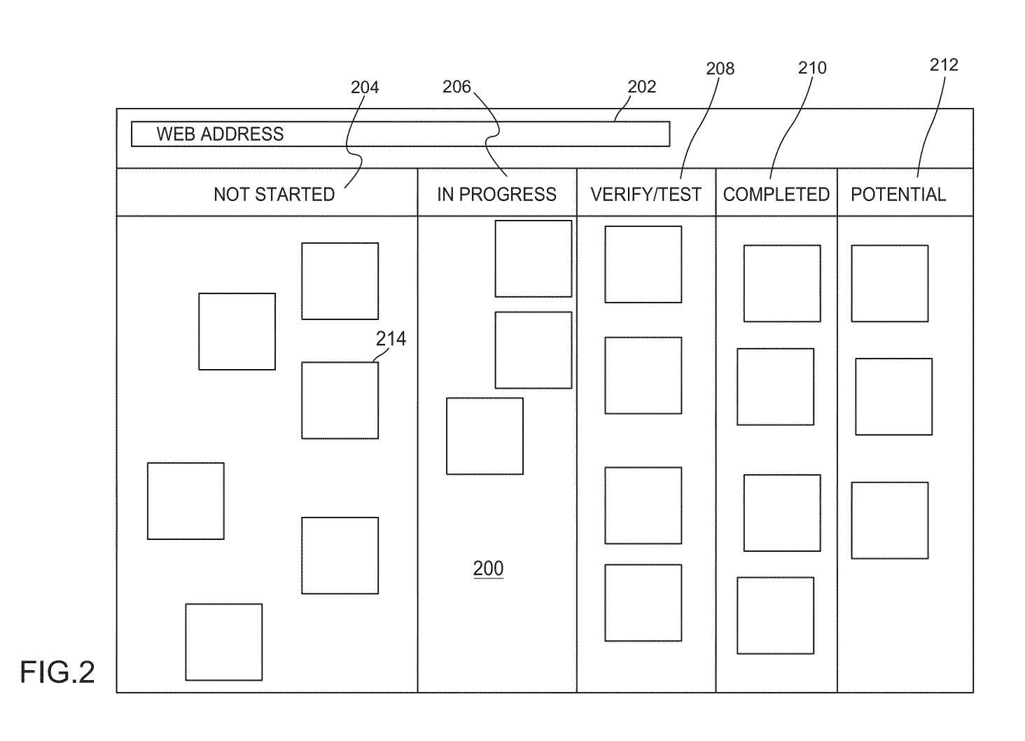

The computing device 100 can be any device including a computer, a server, a laptop, a tablet, a PDA (personal digital assistant), a smart phone (Windows® Phone, IPhone®, Android®) and the like. In various embodiments, computing device 100 can be a smart board that includes wired or wireless connection to a network. Suitable processors include, by way of example, both general and special purpose microprocessors including controllers, FPGA, ASICS and the like. The processor 102 is capable of processing instructions stored in memory 108 for execution within the computing device 100. The display 104 can be any type of display including VGA, LCD, OLED, retina display, touchscreen and the like. The display 104 can display information including a webpage that has an electronic version of the scrum board 200 (as shown in FIG. 2) or the actual electronic scrum board 200 (e.g., via a graphical user interface of a webpage, a mobile application, other software program, or any other suitable graphical user interface). The display 104 can include a window for video conferencing (e.g. picture in picture) with other team members who are not able to be physically present at a scrum project meeting. This allows for better interactions during a daily scrum project meetings between local and remote team members in order to discuss the status of various tasks. The input device 106 can be any type of device including a keyboard, a mouse, a touchpad, a trackball, a pointing device, a finger, a gesture, such as a hand gesture, and the like. In accordance with various embodiments where the display 104 is, for example, a touchscreen or a display of a mobile device, the display 104 can also be configured as the input device 106.

The memory 108 can be read only memory or random access memory, volatile and nonvolatile memory. The memory 108 can also be semiconductor memory devices, such as EPROM, EEPROM, flash memory devices, magnetic disks such as internal hard disks and removable disks, magneto-optical disks, CD-ROM disks, DVD, and the like. The memory can store the operating system 110, such Microsoft Windows®, Linux®, Apple Mac OS X® and the like in order to operate the computing device 100. The memory 108 also stores programs, such as programs 112 to operate the electronic version of a scrum board 200, and any other programs 112 to operate the computing device 100 according to embodiments of the invention. A database or databases 114 can also be stored in memory 108 or a memory similar to memory 108. Database 114 can include project information, calendar information, project status information, personnel information, statistical information, manuals, media files, instructions, project folder, drawings, documents and the like.

The communication interface 116 allows the computing device 100 to communicate via a wired connection or a wireless connection. The wired connection can include USB, parallel, serial, Ethernet, FireWire, thunderbolt and the like. Wireless connection can include Zigbee, Wi-Fi, near field communications (NFC), satellite, cellular, infrared, radio frequency, LAN, WAN, WLAN and the like. Output device 118 may include similar wired or wireless connections or may be different types of connections. Network bus 120 allows for wired or wireless communication between the various components of the computing device 100.

FIG. 2 illustrates am exemplary scrum board 200 according to an embodiment of the invention. The scrum board 200 can be in the form of a webpage with one or more graphical interactive user elements accessible by a web address 202 or a graphical user interface renderable on one or more display devices or computing devices, including mobile computing devices. The scrum board 200 can be divided into various sections, also referred to as status regions, such as “not started” 204, “in progress, “completed” 210, “potential” 212 and the like. The sections can contain sticky notes 214 that contain information about a portion of the project, such as a task as discussed below. While referred to and depicted as “sticky notes” herein, it will be apparent in view of this disclosure that any other suitable interactive user interface elements can be used in accordance with various embodiments such as but not limited to, for example, icons, avatars, and/or any other suitable visualization or other interactive user interface element.

A sticky note 214 located in the “not started” 204 section, is a task that has not been acted on. This may be due to the sticky note 214 being recently added to the “not started” section, or the time to start that task has not commenced, or no team member has been assigned to work on that task or the like. A sticky note 214 located in the “in progress” 206 section, is a task that is being worked on by a team member assigned to that task. A sticky note 214 located in the “verify/test” 208 section, is a task that is being verified or tested on by team member assigned to that task. A sticky note 214 located in the “completed” 210 section, is a task that has been completed by the team member assigned to that task. A sticky note 214 located in the “potential” 212 section, is a task that is being proposed or considered and could potentially move to the “not started” 204 section.

Any input device including a human finger or a stylus can electronically move the sticky notes 214. That is, the graphical user interface is configured to receive the input from the input device, where the input indicates the desired location of the sticky note 214 relative to the display, and implement the task of changing the relative position of the sticky note 214 relative to the display, thereby giving an indication that the sticky note has been moved. Based on the input from the input device, a processor (described hereinbelow) can execute instructions to cause the graphical user interface to display the sticky note 214 at the new position. Based on the input from the input device, the processor can execute instructions to cause the graphical user interface to display a representation of the movement of the sticky note 214 from the first location to the new position. The sticky notes 214 can be moved by a team member located locally (e.g. in the room) or remotely. The sticky notes 214 can be arranged in the section in any order desired by the user including alphabetical, time to be completed, time completed, numerical, color, dates, team member assigned, and any other order desired. Sticky notes 214 can also be arranged horizontally, vertically, diagonally in line with respect to another sticky note 214 or any other arrangement desired by the user. Sticky notes 214 can be arranged with the most important sticky note 214 located at top left-hand corner of a section and additional sticky notes 214 to the right or down from it. The sticky notes 214 can also be arranged with the most important sticky note 214 on the top right-hand corner of the section and additional sticky notes 214 to the left or down from it. This latter arrangement allows for a scrum board 200 located in a country in which the user reads from right to left (e.g. Japan).

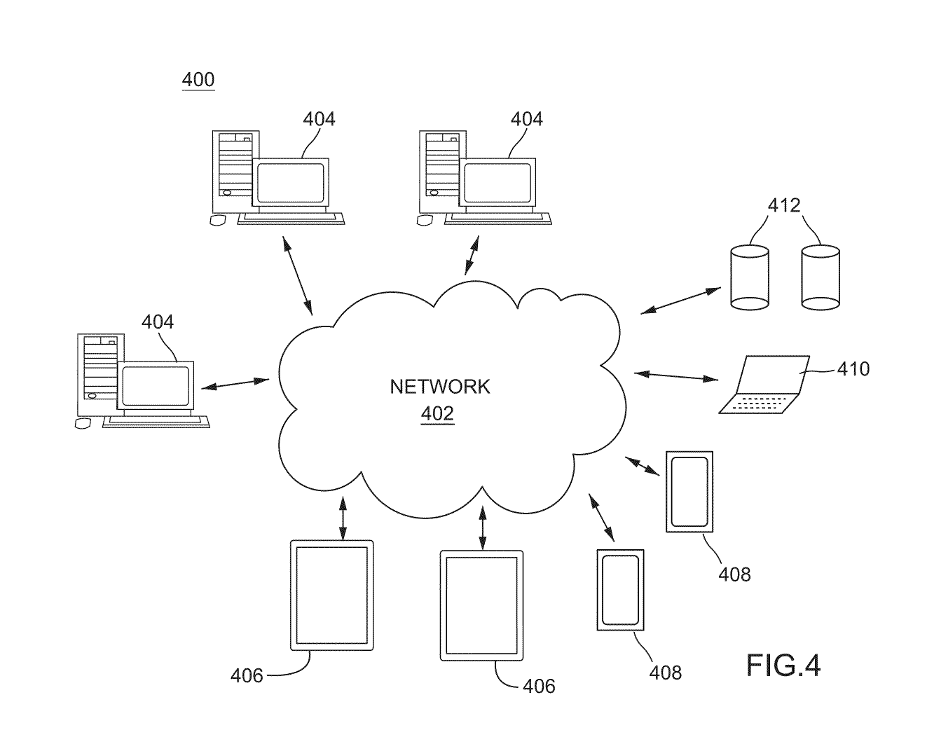

The scrum board 200 can be electronically saved to memory 108 or saved to the external memory connected to the computing device 100 or connected by a network. The scrum board 200 can be accessed by any networked computing device as shown in FIG. 4 through, for example, a secured remote access (e.g. VPN (virtual private network)). The scrum board 200 can also be accessed via the Internet as a webpage such as to web address 202. Once accessed, the scrum board 200 can be viewed and manipulated remotely as desired by the user. Any other user accessing the scrum board 200 at the same time will also be able to view any changes made by any other user.

Access to the scrum board 200 and what can be seen by the user and what can be manipulated by the user can be controlled based on login credentials of the user. Login credentials can be username and password or biometric data (e.g. fingerprint, retina scan) and the like. Thus, users, who are a part of a certain group such as marketing, only need access to the portion of the scrum board 200 that contains marketing tasks or information. Similarly, users, who are part of engineering, only need access the portion of the scrum board 200 that contains engineering tasks or information. In effect, only the sticky notes 214 that the user is allowed or authorized to access will be displayed and the others will be blacked out or not displayed. This allows the project lead or manager to limit access to confidential information or trade secret information to the appropriate user or users.

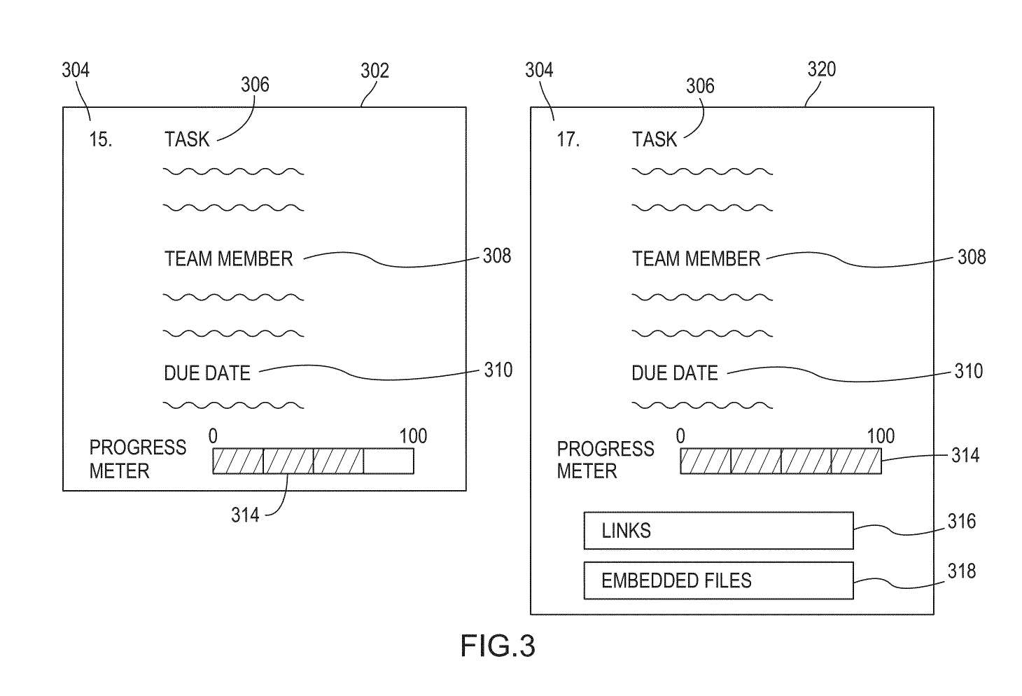

FIG. 3 illustrates exemplary interactive user interface elements (e.g., sticky notes as shown) that can be used according to embodiments of the invention. Sticky note 302 can be, for example, similar to sticky notes 214 and contains various information, such as a task number 304 for the task. Sticky note 302 also includes task information 306 that includes the task title and a description of the task. Team member or team members 308 can also be displayed on sticky note 302 along with the due date 310 of the task. A progress meter 314 allows the user to quickly view the progress of the task. Since the sticky note 302 is electronic in nature, the user can easily modify the task number 304, the task information 306, the team member 308, the due date 310 and the progress meter 314.

The task number 304 can be based on priority of the task or randomly assigned. If based on priority, in various embodiments, the lower number, the more important the task or in various embodiments, the higher the number, the more important the task. The task information 306 can be for a task such as develop website, draft drawings, develop prototype, or identify manufacturers, and the like. Team member 308 can include one or more members. Team members can be assigned to the task based on job title, seniority, training and the like. Within each task, each member can be individually assigned a specific function within the task.

Due date 310 can be a hard due date or soft due date as desired by the user. The progress meter 314 can be any type of indicator that indicates the progress towards the completion of the task. The progress meter 314 can be LEDs with various colors such as red, yellow and green to alert the user. The progress meter 314 can also flash as the task moves towards completion and then remain solid once the task is completed or vice versa. In accordance with various embodiments, if a task has not been completed, the team member can be alerted on the due date and/or at a predetermined time prior to the due date (e.g., days or weeks before the due date). The alert can be via email, text message, pager, phone call, fax or the like.

In various embodiments, the sticky note 302 can be any color desired by the user. Further, sticky note 302 can change color based upon which section on scrum board 200 it is located. For example, the sticky note 302 can be yellow in color when it is located in the “not started” section 204 and then change to blue in color when it is moved to the “in progress” section 206. In still various embodiments, the sticky note 302 can change colors depending on the status of the task and time to completion. For example, if the task completion time is still on a predetermined schedule, then the sticky note 302 may retain its standard color. However, if the time to completion of the task is a little behind the predetermined schedule, the sticky note 302 can change color from blue to yellow, for example. If the time to completion of the task is seriously behind the predetermined schedule, the sticky note 302 can change color from blue to red, for example. In various embodiments, the sticky note 302 can indicate time to completion by flashing, vibrating, or any other visual indication of the status of the task.

In various embodiments, statistical information about the task can also be generated as needed by the user. The computing device 100 is capable of retaining a record or logs of events that occur on the scrum board 200 such as user login, when (via timestamp) the sticky note 302 was created, modified or last saved, all versions of the sticky note 302 or the scrum board 200, and the like. For example, the amount of time in which a team member takes to complete a task or the number of times the team member did not complete a task in a timely manner can be monitored. Additionally, the amount time to complete a particular task such as designing a website can be tracked so that future projects can benefit from a more accurate estimate. Other statistical information can include the amount time it takes to complete a task with one team member assigned versus multiple team members so that an accurate number of team members can be allocated if the task is repeated on another project.

In other embodiments, each sticky note 302 can be saved individually so that it can be reused in another project. This may be accomplished through cloning the project, renaming it, and saving it off as another project. The scrum board movements for each day can also be electronically saved so that team members who missed the meeting due to a conflict, sick or on vacation can monitor each meeting and what happened at the scrum project meeting. In various embodiments, based on login information for a team member, multiple scrum boards 200 may be associated with that team member so that the member can quickly and easily view the status of his tasks for the various projects that he is assigned to. Further, it is possible for a task on one project to be the same task on another project so that an update on sticky note 302 for that task can be automatically updated on a scrum board 200 of another project including being correspondingly moved from one section to another section of the other scrum board 200.

Referring still to FIG. 3, sticky note 320 is illustrated according to various embodiments of the invention. Sticky note 320 can be similar to sticky note 302 including the various embodiments discussed herein, however, may include additional portions. For example, links to documents, webpages, files, and the like may be included on the sticky note 320. This helps to organize documents and information related to that task on sticky note 320 so that they are easily and quickly accessible by the team member. Embedded files 318 such as media files including pictures, video, audio, source code, object code, text, and the like may be embedded in sticky note 320 accessed by the team member or project lead. For example, verification or testing media files (video and audio) and data (test results may be embedded so that the project lead can verify the test was actually completed and the results were satisfactory. This allows independent verification of the test and its results.

FIG. 4 illustrates various electronic devices that can access a network on which the computing device 100 containing the electronic scrum board 200 is connected to. The network 402 can be distributed network (Internet), WAN, LAN, Wi-Fi, and the like. A user via a wired or wireless connection can access the network 402. The electronic devices can include desktop computers 404, tablets 406, smart phones 408, and laptop 410. Also illustrated in FIG. 4 are remote databases 412 that can be accessed by the computing device 100 and the electronic devices discussed herein. The team member can use any of the electronic devices in order to access the computing device 100 or the scrum board 200 from any remote location.

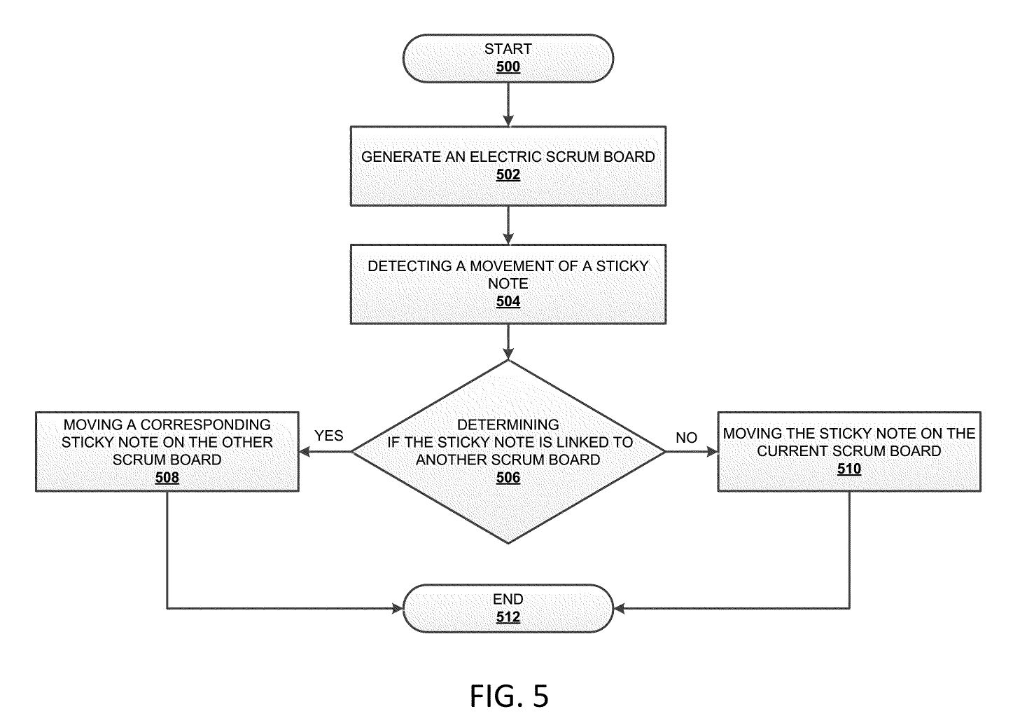

FIG. 5 illustrates a method of moving the sticky note 214 according to an embodiment of the invention. The method can start at 500 and can be implemented via software or by physically moving the sticky note 214. Additionally, the method steps do not have to be performed in order and can be a combination of both software and physical movement.

At step 502, the computing device 100 can generate electronic scrum board 200 as discussed herein. At step 504, the software can detect the movement of sticky note 214 from one section of the electronic scrum board 200 to another section. At step 506, the software determines if the sticky note 214 is linked to another electronic scrum board 200. For example, there could be a common task that is on the current electronic scrum board 200 and is exactly the same or similar task on another scrum board 200. Thus, a movement of that sticky note 214 to the “completed” 210 section on the current electronic scrum board 200 would be relevant to the other electronic scrum board 200 that the sticky note 214 is linked to. If the sticky note 214 is linked to another scrum board 200 then at step 508, the corresponding sticky note 214 on the other scrum board 200 is correspondingly moved. If the sticky note 214 is not linked to another scrum board 200, then at step 510 the sticky note 214 on the current electronic scrum board 200 is moved. The method ends at step 512. The movement of sticky note 214 can be done physically at the local location of scrum board 200 by a user or by the user remotely accessing the scrum board 200.

The present invention can be realized as computer-executable instructions on computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

The many features and advantages of the invention are apparent from the detailed specification, and thus, it is intended by the appended claims to cover all such features and advantages of the invention, which fall within the true spirit, and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A computing device for generating an electronic scrum board, comprising:
a processor that controls the computing device;
a memory that stores software with instructions to generate the electronic scrum board;
a display that displays the electronic scrum board having a plurality of sections, each section includes a plurality of electronic sticky notes;
an input device that receives an input from a user; and
a communication interface that allows the computing device to communicate with a remote device via a wired or wireless connection, wherein based on a log in credential of the user, the user is only allowed to view and manipulate an authorized sticky note of the plurality of electronic sticky notes.

2. The computing device of claim 1, wherein the plurality of electronic sticky notes comprises:
a task number;
information about a task;
a due date for the task; and
a progress meter that tracks a status of the task.

3. The computing device of claim 1, wherein the plurality of electronic sticky notes includes an embedded media file.

4. The computing device of claim 3, wherein the media file includes video and audio.

5. The computing device of claim 1, wherein the plurality of electronic sticky notes includes a link to a document, a web page or a file.

6. The computing device of claim 1, wherein modifications to the electronic scrum board is saved in the memory.

7. The computing device of claim 1, wherein the display include a portion that displays a video conferencing window.

8. The computing device of claim 2, wherein the plurality of electronic sticky notes changes from a first color to a second color depending a completion status of the task.

9. The computing device of claim 2, wherein the user assigned to the task is alerted when the task's due date has passed.

10. The computing device of claim 2, wherein a report based on performance level of the user based on the status of the task is generated by the processor.

11. The computing device of claim 3, wherein the embedded media file includes a video of a test result.
